(19) United States
(12) Patent Application Publication
(10) Pub. No.: US 2013/0086514 A1
(43) Pub. Date: Apr. 4, 2013

(54) User Inferface

(71) Applicant: Lene Leth Rasmussen, Copenhagen V. (DK)

(72) Inventor: Lene Leth Rasmussen, Copenhagen V. (DK)

(73) Assignee: NOKIA CORPORATION, Espoo (FI)

(21) Appl. No.: 13/250,567

(22) Filed: Sep. 30, 2011

(51) Int. Cl. G06F 3/048

(52) U.S. Cl. 715/792

(57) ABSTRACT

An apparatus comprising: a first display area; a second display area; and a gap, between an edge of the first display area and an edge of the second display area, separating the first display area from the second display area; and a display controller configured, in response to detection of a first criteria, to display a user interface element in a first configuration as a user interface element divided into a first portion and a second portion, with the first portion of the user interface element displayed at the edge of the first display area and the second portion of the user interface element displayed at the edge of the second display area; and configured, in response to detection of a second criteria, to display a user interface element in a second configuration as a user interface element divided into a third portion, a fourth portion and an intermediate portion between the third portion and fourth portion, with the third portion of the user interface element displayed at the edge of the first display area, the fourth portion of the user interface element displayed at the edge of the second display area and the intermediate portion of the user interface element not displayed.

### TECHNOLOGICAL FIELD

Embodiments of the present invention relate to a user interface comprising a first display area and a second display area.

### BACKGROUND

A user interface is an interface by which an apparatus communicates to a user and/or by which a user communicates to the apparatus.

A user interface may comprise one or more displays with distinct display areas.

### BRIEF SUMMARY

It would be desirable to use two distinct display areas separated by a gap as a single display area. However, the presence of the gap can make this problematic as it creates an interrupt in the single display area.

According to various, but not necessarily all, embodiments of the invention there is provided an apparatus comprising: a first display area; a second display area; and a gap, between an edge of the first display area and an edge of the second display area, separating the first display area from the second display area; and a display controller configured, in response to detection of a first criteria, to display a user interface element in a first configuration as a user interface element divided into a first portion and a second portion, with the first portion of the user interface element displayed at the edge of the first display area and the second portion of the user interface element displayed at the edge of the second display area; and configured, in response to detection of a second criteria, to display a user interface element in a second configuration as a user interface element divided into a third portion, a fourth portion and an intermediate portion between the third portion and fourth portion, with the third portion of the user interface element displayed at the edge of the first display area, the fourth portion of the user interface element displayed at the edge of the second display area and the intermediate portion of the user interface element not displayed.

According to various, but not necessarily all, embodiments of the invention there is provided a method comprising: in response to detection of a first criteria, displaying a user interface element in a first configuration as a user interface element divided into a first portion and a second portion, with the first portion of the user interface element displayed at the edge of a first display area and the second portion of the user interface element displayed at an edge of a second display area separated from the first display area by a gap; and in response to detection of a second criteria, displaying a user interface element in a second configuration as a user interface element divided into a third portion, a fourth portion and an intermediate portion between the third portion and fourth portion, with the third portion of the user interface element displayed at the edge of the first display area, the fourth portion of the second portion displayed at the edge of the second display area and the intermediate portion of the user interface element not displayed.

According to various, but not necessarily all, embodiments of the invention there is provided an apparatus comprising: at least one processor; and at least one memory including computer program code the at least one memory and the computer program code configured to, with the at least one processor, cause the apparatus at least to perform in response to detection of a first criteria, displaying a user interface element in a first configuration as a user interface element divided into a first portion and a second portion, with the first portion of the user interface element displayed at the edge of a first display area and the second portion of the user interface element displayed at an edge of a second display area separated from the first display area by a gap; and in response to detection of a second criteria, displaying a user interface element in a second configuration as a user interface element divided into a third portion, a fourth portion and an intermediate portion between the third portion and fourth portion, with the third portion of the user interface element displayed at the edge of the first display area, the fourth portion of the second portion displayed at the edge of the second display area and the intermediate portion of the user interface element not displayed.

### BRIEF DESCRIPTION

For a better understanding of various examples of embodiments of the present invention reference will now be made by way of example only to the accompanying drawings in which:

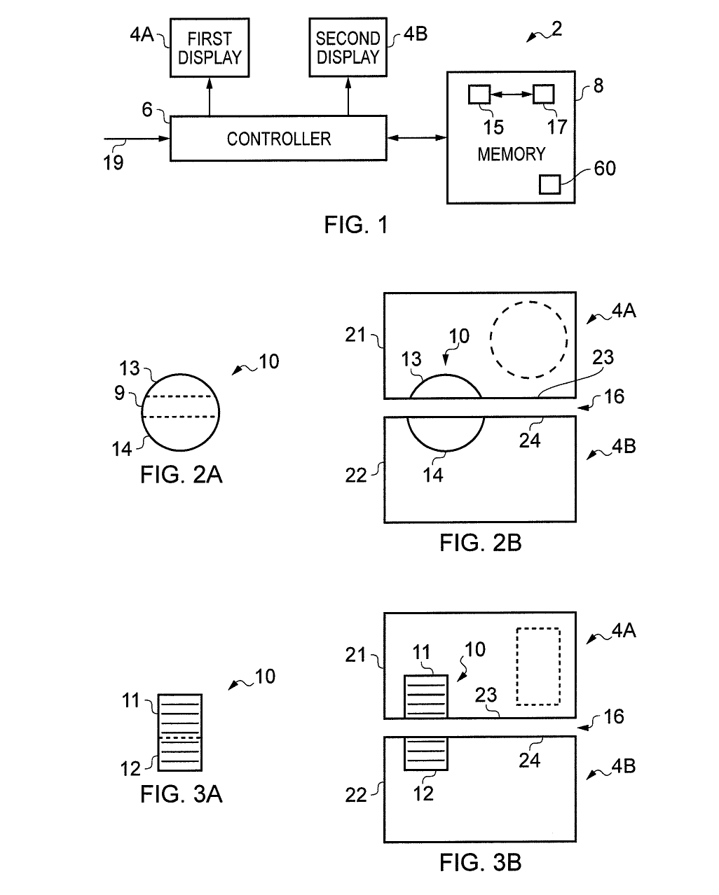

FIG. 1 illustrates an example of an apparatus;

FIG. 2A illustrates a user interface element divided for the second configuration;

FIG. 2B illustrates a user interface element used in the second configuration;

FIG. 3A illustrates a user interface element divided for the first configuration;

FIG. 3B illustrates a user interface element used in the first configuration;

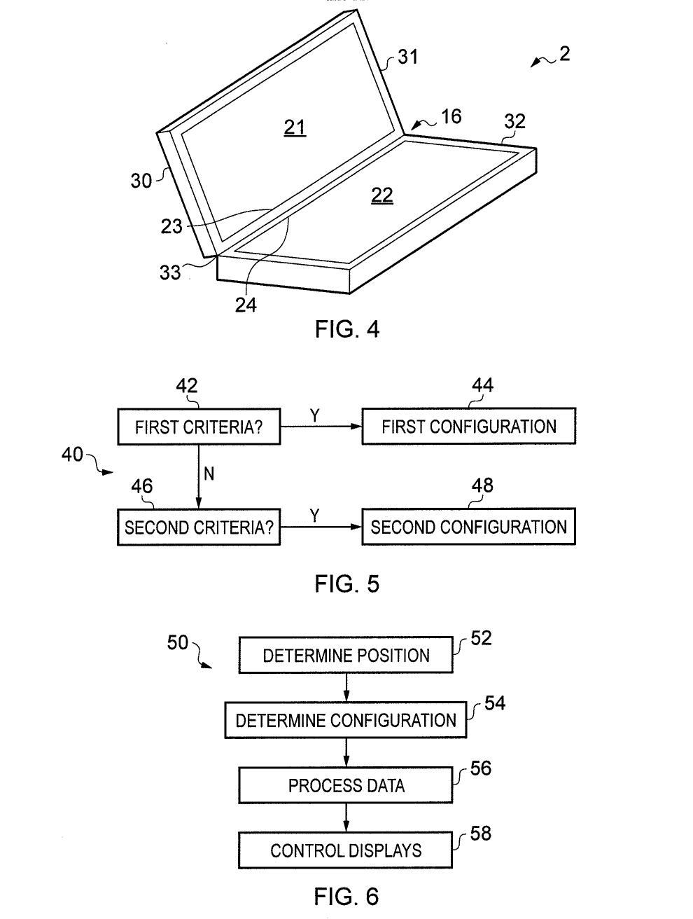

FIG. 4 illustrates in perspective view an example of a dual display apparatus;

FIG. 5 illustrates a method for determining whether to use the user interface element in a first configuration or a second configuration; and

FIG. 6 illustrates a method for controlling the user interface provided by multiple display areas.

### DETAILED DESCRIPTION

The Figures illustrate an apparatus 2 comprising:

a first display area 21;
a second display area 22; and
a gap 16, between an edge 23 of the first display area 21 and an edge 24 of the second display area 22, separating the first display area 21 from the second display area 22; and
a display controller 6 configured, in response to detection of a first criteria, to display a user interface element 10 in a first configuration as a user interface element 10 divided into a first portion 11 and a second portion 12, with the first portion 11 of the user interface element 10 displayed at the edge 23 of the first display area 21 and the second portion 12 of the user interface element 10 displayed at the edge 24 of the second display area 22; and configured, in response to detection of a second criteria, to display a user interface element 10 in a second configuration as a user interface element 10 divided into a third portion 13, a fourth portion 14 and an intermediate portion 9 between the third portion 13 and fourth portion 14, with the third portion 13 of the user interface element 10 displayed at the edge 23 of the first display area 21, the fourth portion 14 of the user interface element 10 displayed at the edge 24 of the second display area 22 and the intermediate portion 9 of the user interface element 10 not displayed.

FIG. 1 illustrates an example of an apparatus 2 comprising: a first display 4A defining a first display area 21; a second display 4B defining a second display area 22; and a display controller 6 configured to control simultaneous display of different parts of a user interface element 10 on both the first display area 21 and the second display area 22.

The apparatus 2 may, for example, be an electronic apparatus such as a personal digital assistant, personal media player, mobile cellular telephone, personal computer, a point of sale terminal etc. In some embodiments the apparatus 2 may be a hand-portable apparatus, that is, an apparatus that is sized to be carried in the palm of a hand or in a jacket pocket.

The display controller 6 is configured, in response to detection of a first criteria, to display the user interface element 10 in a first configuration across both the first display area 21 and the second display area 22. An example of this first configuration is illustrated in FIG. 3B.

The display controller 6 is also configured, in response to detection of a second criteria, to display the user interface element 10 in a second configuration across both the first display area 21 and the second display area 22. An example of this second configuration is illustrated in FIG. 2B.

Although the term criteria is normally used to indicate more than one criterion, in this document the term ‘criteria’ should be understood to indicate one or more criterion.

FIGS. 2B and 3B illustrate one possible layout of the first display area 21 and the second display area 22.

In this example, the first display area 21 and the second display area 22 are ‘landscape’ with a width dimension exceeding a height dimension. In other embodiments the first display area 21 and the second display area 22 may be portrait with a width dimension less than a height dimension.

In this example, the first display area 21 and the second display area 22 are the same size. In other embodiments they may be of different size.

The first display area 21 has an edge 23 nearest the second display area 22. The second display area 22 has an edge 24 nearest the first display area 21. The edges 23 and 24 are in this example, but not necessarily all examples, rectilinear and parallel. The distance separating the edges 23, 24 may in some embodiments be less than 5 mm.

There is a gap 16 between the edge 23 of the first display area 21 and the edge 24 of the second display area 22. The gap 16 separates the first display area 21 from the second display area 22 and does not operate as a display. The gap 16 is therefore an area where a user interface element 10 cannot be displayed.

If a user interface element 10 is to straddle the first display area 21 and the second display area 22, then the user interface element 10 may be rendered on the first display area 21 and the second display area 22 as if the first display area 21 and the second display area 22 are the whole of a single display area (first configuration) or as if the first display area 21 and the second display area 22 are parts of a single display area that has a part obscured by the gap 16 (second configuration).

FIGS. 3A and 3B illustrate the first configuration in detail.

FIG. 3A illustrates a user interface element 10 divided into a first portion 11 and a second portion 12. The user interface element 10 is divided into only two portions.

FIG. 3B illustrates the user interface element 10 of FIG. 3A displayed in a first configuration. The first portion 11 of the user interface element 10 is displayed at the edge 23 of the first display area 21. The second portion 12 of the user interface element 10 is displayed at the edge 24 of the second display area 22. There is continuity between the first portion 11 at the edge 23 of the first display area 21 and the second portion 12 at the edge 24 of the second display area 22.

FIGS. 2A and 2B illustrate the second configuration in detail.

FIG. 2A illustrates a user interface element 10 divided into a third portion 13, a fourth portion 14 and an intermediate portion 9 between the third portion 13 and fourth portion 14,

FIG. 2B illustrates the user interface element 10 of FIG. 2A displayed in a second configuration. The third portion 13 of the user interface element 10 is displayed at the edge 23 of the first display area 21. The fourth portion 14 of the user interface element 10 displayed at the edge 24 of the second display area 22. The intermediate portion 9 of the user interface element 10 is not displayed. The intermediate portion of the user interface element 10 is sized and orientated to correspond to the gap 16.

FIG. 4 illustrates in perspective view an example of a dual display apparatus 2. In this example the first display area 21 is rotatable relative to the second display area 22 about an axis in the gap 16.

The apparatus 2 comprises a housing 30 that has a first housing part 31 connected to a second housing part 32 via a hinge 33. The first housing part 31 supports the first display 4A defining the first display area 21. The second housing part 32 supports the second display 4B defining the second display area 22.

The straight edge 23 of the first display area 21 nearest the gap 16 is parallel to the straight edge 24 of the second display area 22 nearest the gap 16. Separation between the edges 23, 24 is constant and may be less than 5 mm.

The gap 16 is occupied in this example by a portion of the first housing part 31, the hinge 33 and a portion of the second housing part 32.

The first display 4A and/or the second display 4B may be a touch sensitive display. A touch sensitive display is capable of providing output to a user and also capable of simultaneously receiving touch or proximity input from a user while it is displaying.

A user interface element 10 may be any item that is displayable on a display used as a user interface. It may, for example, be a background image. It may, for example, be a foreground image. It may, for example, be an icon, widget or similar. It may, for example, be output from an application such as a web-page or table.

The user interface element 10 may be static or dynamic. Static means that it does not change appearance over time. Dynamic means that it changes appearance (shape or color etc) over time.

The user interface element 10 may be fixed or moveable. Fixed means that it does not change position over time. Moveable means that it changes position over time. If may, for example, be movable under the control of a user.

FIG. 5 illustrates a method 40.

At block 42 either a first criteria is detected or is not detected. If a first criteria is detected, the method moves to block 44. If a first criteria is not detected, the method moves to block 46.

At block 46 either a second criteria is detected or is not detected. If a second criteria is detected, the method moves to block 48.

It will be appreciated that if there are only two criteria states namely first criteria and NOT first criteria, then block 46 is implicit in block 42 because detecting at block 42 that a first criteria is not detected is detecting the second criteria.

At block 44, in response to detection of the first criteria, a user interface element 10 is displayed in a first configuration (e.g. FIG. 3B) as a user interface element 10 divided into a first portion 11 and a second portion 12, with the first portion 11 of the user interface element 10 displayed at the edge 23 of a first display area 21 and the second portion 12 of the user interface element 10 displayed at an edge 24 of a second display area 22 separated from the first display area 21 by a gap 16.

At block 48, in response to detection of the second criteria, a user interface element 10 is displayed in a second configuration (e.g. FIG. 2B) as a user interface element 10 divided into a third portion 13, a fourth portion 14 and an intermediate portion 9 between the third portion 13 and fourth portion 14, with the third portion 13 of the user interface element 10 displayed at the edge 23 of the first display area 21, the fourth portion 14 of the user interface element 10 displayed at the edge 24 of the second display area 22 and the intermediate portion 9 of the user interface element 10 not displayed.

The first criteria may require that the user interface element 10 is proximal to and extends beyond the edge 23 of the first display area 21 or the edge 24 of the second display area 22. For example, referring to FIG. 3B there is illustrated a user interface element 10 that straddles the edges 23, 24 and is consequently divided. There is also illustrated, using dotted lines, the undivided user interface element 10 positioned distal from the edge 23.

The second criteria may require that the user interface element 10 is proximal to and extends beyond the edge 23 of the first display area 21 or the edge 24 of the second display area 22. For example, referring to FIG. 2B there is illustrated a user interface element 10 that straddles the edges 23, 24 and is consequently divided. There is also illustrated, using dotted lines, the undivided user interface element 10 positioned distal from the edge 23.

The first criteria and second criteria may be tested by evaluating a parameter 15 (FIG. 1). The first criteria may, for example, require that a parameter 15 associated with the user interface element 10 has a particular value and the second criteria may, for example, require that the parameter 15 associated with the user interface element 10 has a different value.

The use of criteria allows the apparatus 2 to discriminate between user interface elements 10 on that basis of, for example, characteristics of the user interface element 10. The first criteria may be associated with a particular set of characteristics and the second criteria may be associated with a second, non-overlapping set of characteristics.

For example, the first criteria may be satisfied when the user interface element 10 comprises structured content, particularly text content, for a user. The user interface element 10 may, for example, be a web-page or a list etc

For example, the second criteria may be satisfied when the user interface element 10 is an aesthetic graphical item or an element whose proportions should be maintained for aesthetic reasons. The user interface element 10 may, for example, be a background image, an icon image, a widget image etc.

Data 17 representing a user interface element 10 may be pre-processed to determine the parameter value 15 associated with the user interface element 10. The parameter 15 may then be stored in memory 8 in association with the data 17 representing the user interface element 10. The parameter 15 may, for example, be metadata or the number of pixels used for the user interface element 10. The parameter 15 may be delivered 19 with the data 17 representing the user interface element 10.

Alternatively, data representing a user interface I element may be processed by the apparatus 2 to detect the first criteria or the second criteria.

FIG. 6 illustrates a method 50.

At block 52, a position of the user interface element 10 is determined. The method continues to block 54 if the user interface element 10 extends beyond the edge 23 of the first display area 21 or the edge 24 of the second display area 22.

At block 54, the method 50 determines a configuration for the user interface element 10. This block has been described in detail with reference to the method 40 of FIG. 5.

Next at block 56, in response to detection of a first criteria at block 54, the controller 6 processes data representing the user interface element 10 to form the first portion 11 and the second portion 12 for display. However, in response to detection of a second criteria at block 54, the controller 6 processes data representing the user interface element to form the third portion 13 and the fourth portion 14 for display.

Next at block 58 the controller 6 controls the first display 4A and the second display 4B to display the user interface element 10 either in the first configuration (display the first portion 11 and the second portion 12) or in the second configuration (display the third portion 13 and the fourth portion 14).

Referring back to FIG. 1, the controller 6 may be implemented using instructions that enable hardware functionality, for example, by using executable computer program instructions in a general-purpose or special-purpose processor that may be stored on a computer readable storage medium (disk, memory etc) to be executed by such a processor.

In an embodiment where the controller 6 is provided using a processor, the processor 6 is configured to read from and write to the memory 8. The processor 6 may also comprise an output interface via which data and/or commands are output by the processor 6 and an input interface via which data and/or commands are input to the processor 6.

The memory 8 stores a computer program 60 comprising computer program instructions that control the operation of the apparatus 2 when loaded into the processor 6. The computer program instructions 60 provide the logic and routines that enables the apparatus to perform the methods illustrated in FIGS. 2A, 2B, 3A, 3B, 5 and 6]. The processor 6 by reading the memory 8 is able to load and execute the computer program 60.

The apparatus therefore comprises: at least one processor 6; and

at least one memory 8 including computer program code 60
the at least one memory 8 and the computer program code 60 configured to, with the at least one processor 6, cause the apparatus 2 at least to perform in response to detection of a first criteria, displaying a user interface element in a first configuration as a user interface element divided into a first portion and a second portion, with the first portion of the user interface element displayed at the edge of a first display area and the second portion of the user interface element displayed at an edge of a second display area separated from the first display area by a gap; and
in response to detection of a second criteria, displaying a user interface element in a second configuration as a user interface element divided into a third portion, a fourth portion and an intermediate portion between the third portion and fourth portion, with the third portion of the user interface element displayed at the edge of the first display area, the fourth portion of the second portion displayed at the edge of the second display area and the intermediate portion of the user interface element not displayed, and/or perform any other of the methods described.

The computer program may arrive at the apparatus 2 via any suitable delivery mechanism. The delivery mechanism may be, for example, a non-transitory computer-readable storage medium, a computer program product, a memory device, a record medium such as a compact disc read-only memory (CD-ROM) or digital versatile disc (DVD), an article of manufacture that tangibly embodies the computer program 60. The delivery mechanism may be a signal configured to reliably transfer the computer program 60. The apparatus 2 may propagate or transmit the computer program 60 as a computer data signal.

Although the memory 8 is illustrated as a single component it may be implemented as one or more separate components some or all of which may be integrated/removable and/or may provide permanent/semi-permanent/dynamic/cached storage.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ refers to all of the following:
(a) hardware-only circuit implementations (such as implementations in only analog and/or digital circuitry) and
(b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and
(c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.”

As used here ‘module’ refers to a unit or apparatus that excludes certain parts/components that would be added by an end manufacturer or a user. The controller may be a module.

The blocks illustrated in the FIGS. 5 and 6 may represent steps in a method and/or sections of code in the computer program 60. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

For example, although the above described examples have used only two distinct display areas, the pair of display areas may be considered as any permutation or combination of two adjacent display areas in a multi-display area system.

Although the interface 16 is illustrated as a narrow gap in some embodiments it may be large, for example larger than a dimension or maximum dimension of a display area. The display areas do not need to be attached to each other. If the pair of display areas are not attached to each other, a mechanism may be provided for measuring the distance between display areas. For example, transmitters and receivers may be used to measure the distance using time of flight estimation.

For example there may be provided an apparatus comprising:
means for displaying, in response to detection of a first criteria, a user interface element in a first configuration as a user interface element divided into a first portion and a second portion, with the first portion of the user interface element displayed at the edge of a first display area and the second portion of the user interface element displayed at an edge of a second display area separated from the first display area by a gap; and
means for displaying, in response to detection of a second criteria, a user interface element in a second configuration as a user interface element divided into a third portion, a fourth portion and an intermediate portion between the third portion and fourth portion, with the third portion of the user interface element displayed at the edge of the first display area, the fourth portion of the second portion displayed at the edge of the second display area and the intermediate portion of the user interface element not displayed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/we claim:

1. An apparatus comprising:
a first display area;
a second display area; and
a gap, between an edge of the first display area and an edge of the second display area, separating the first display area from the second display area; and
a display controller configured, in response to detection of a first criteria, to display a user interface element in a first configuration as a user interface element divided into a first portion and a second portion, with the first portion of the user interface element displayed at the edge of the first display area and the second portion of the user interface element displayed at the edge of the second display area; and configured, in response to detection of a second criteria, to display a user interface element in a second configuration as a user interface element divided into a third portion, a fourth portion and an intermediate portion between the third portion and fourth portion, with the third portion of the user interface element displayed at the edge of the first display area, the fourth portion of the user interface element displayed at the edge of the second display area and the intermediate portion of the user interface element not displayed.

2. An apparatus as claimed in claim 1, wherein the intermediate portion of the user interface element is sized and orientated to correspond to the gap

3. An apparatus as claimed in claim 1, configured, in response to detection of a first criteria, to processes data representing the user interface element to form the first portion and the second portion for display and
configured, in response to detection of a second criteria, to processes data representing the user interface element to form the third portion and the fourth portion for display.

4. An apparatus as claimed in claim 1, wherein, for the first configuration, the user interface element is divided into only two portions and there is continuity between the first portion at the edge of the first display area and the second portion at the edge of the second display area.

5. An apparatus as claimed in claim 1, wherein, the first and second criteria both require that the user interface element extends beyond the edge of the first display area or the edge of the second display area.

6. An apparatus as claimed in claim 1, wherein the first criteria requires that a parameter associated with the user interface element has a first value and wherein the second criteria requires that a parameter associated with the user interface element has a second value.

7. An apparatus as claimed in claim 6, wherein the parameter is stored in association with the user interface element.

8. An apparatus as claimed in claim 6, wherein the parameter is provided with data representing the user interface element.

9. An apparatus as claimed in claim 1, configured to detect the first criteria or the second criteria in dependence upon at least one characteristic of the user interface element.

10. An apparatus as claimed in claim 1, configured to detect the first criteria when the user interface element comprises structured data for a user.

11. An apparatus as claimed in claim 1, configured to detect the second criteria when the user interface element is a graphical item.

12. An apparatus as claimed in claim 1, comprising processing data representing a user interface element to detect the first criteria or the second criteria.

13. An apparatus as claimed in claim 1, wherein the first display area is rotatable relative to the second display area about an axis in the gap.

14. A method comprising:
in response to detection of a first criteria, displaying a user interface element in a first configuration as a user interface element divided into a first portion and a second portion, with the first portion of the user interface element displayed at the edge of a first display area and the second portion of the user interface element displayed at an edge of a second display area separated from the first display area by a gap; and
in response to detection of a second criteria, displaying a user interface element in a second configuration as a user interface element divided into a third portion, a fourth portion and an intermediate portion between the third portion and fourth portion, with the third portion of the user interface element displayed at the edge of the first display area, the fourth portion of the second portion displayed at the edge of the second display area and the intermediate portion of the user interface element not displayed.

15. A method as claimed in claim 14, wherein the intermediate portion of the user interface element is sized and orientated to correspond to the gap.

16. A method as claimed in claim 14, comprising processing data representing the user interface element to form the first portion and the second portion for display and comprising processing data representing the user interface element to form the third portion and the fourth portion for display.

17. A method as claimed in claim 14, wherein the first and second criteria both require that the user interface element extends beyond the edge of the first display area or the edge of the second display area.

18. An apparatus comprising:
at least one processor; and
at least one memory including computer program code
the at least one memory and the computer program code configured to, with the at least one processor, cause the apparatus at least to perform
in response to detection of a first criteria, displaying a user interface element in a first configuration as a user interface element divided into a first portion and a second portion, with the first portion of the user interface element displayed at the edge of a first display area and the second portion of the user interface element displayed at an edge of a second display area separated from the first display area by a gap; and
in response to detection of a second criteria, displaying a user interface element in a second configuration as a user interface element divided into a third portion, a fourth portion and an intermediate portion between the third portion and fourth portion, with the third portion of the user interface element displayed at the edge of the first display area, the fourth portion of the second portion displayed at the edge of the second display area and the intermediate portion of the user interface element not displayed.

19. An apparatus comprising means for performing the method of claim 14.

20. A computer program, which when loaded into a processor, enables the processor to perform the method of claim 14.
